(19) United States
(12) Patent Application Publication
(10) Pub. No.: US 2013/0205848 A1
(43) Pub. Date: Aug. 15, 2013

(54) QUARTER-TURN LATCH HAVING COVERED KEY ACCESS

(71) Applicants: Andreas Langenberg, Dusseldorf (DE); Peter Höschler, Velbert (DE); Dieter Ramsauer, Schwelm (DE)

(72) Inventors: Andreas Langenberg, Dusseldorf (DE); Peter Höschler, Velbert (DE); Dieter Ramsauer, Schwelm (DE)

(21) Appl. No.: 13/501,431

(22) PCT Filed: Aug. 10, 2011
(86) PCT No.: PCT/EP2011/004003

§ 371 Date: Jun. 27, 2012

(30) Foreign Application Priority Data
Aug. 12, 2010 (DE) 20 2010 011 311.3

(51) Int. Cl. E05B 17/18; E05C 3/04

(52) U.S. Cl. CPC E05B 17/183; E05C 3/04
USPC 70/455

(57) ABSTRACT

Described is a quarter-turn latch having a key receptacle and a cover for closing the access to the key receptacle, wherein the cover can be folded around an axis parallel to the fastening plane or door of the quarter-turn latch out of an open position into a closed position, and a contour protrudes in the interior of the covet in the region of the axis, which contour is adapted to the contour of the actuating means in such a way that it fixes the actuating means with respect to rotation in the closed position of the cover and accordingly forms a lock safeguard.

The present application claims priority from PCT Patent Application No. PCT/EP2011/004003 filed on Aug. 10, 2011, which claims priority from German Patent Application No. DE 20 2010 011 311.3 filed on Aug. 12, 2010, the disclosures of which are incorporated herein by reference in their entirety.

### BACKGROUND OF THE INVENTION

1. Field of the Invention

The invention is directed to a quarter-turn latch having a key receptacle and a cover for closing the access to the key receptacle.

2. Description of Related Art

It is noted that citation or identification of any document in this application is not an admission that such document is available as prior art to the present invention.

A quarter-turn latch having a key receptacle and a cover for closing the access to the receptacle, wherein the cover can be folded around an axis parallel to the fastening plane of the quarter-turn latch out of an open position into a closed position, is known from U.S. Pat. No. 2,782,625 A. A quarter-turn latch having a key receptacle and a cover in the form of a spring-loaded mask for closing the access to the receptacle is already known from the company catalog of DIRAK Dieter Ramsauer Konstruktionselemente GmbH, Königsfelder Str, 1, 58256 Ennepetal, see Catalog Page 02.24. The arrangement of a sash fastener known from the company catalog of DIRAK under order number 255-9801 uses a blocking mask which is unlocked by inserting a key and serves at the same time to protect against dust.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

It is the object of the invention to improve the sash fastener known from U.S. Pat. No. 2,782,625 A in such a way that, in addition to protecting against dust and locking, it is also possible when the key is withdrawn for the locking position to be indicated (signal effect) also the sash fastener to be arrested in the closed state.

The object is met in that the cover can be folded around an axis parallel to the fastening plane of the quarter-turn latch out of an open position into a closed position, and in that a contour protrudes in the interior of the cover in the region of the axis, which contour is adapted to the contour of the actuating means in such a way that it fixes the actuating means with respect to rotation in the closed position of the cover and accordingly forms a lock safeguard.

This has the advantage of enabling an embodiment form in which the contour is formed by a ring which is connected to the actuating means so as to be rigid against rotation relative to it and which has, at an angular position of its circumferential circle, a notch in which the protruding contour of the cover can be received when the cover is closed and thus allows the cover to be closed, while outside this notch the protruding contour of the cover contacts the circumference of the ring and accordingly holds the cover open against spring force.

In case of the above-mentioned embodiment form, an embodiment form is conceivable in which the folding axis of the cover is formed by the flange of the quarter-turn latch housing. Alternatively, the folding axis of the cover can also be formed by a housing which is held by the quarter-turn latch housing, particularly by the flange thereof.

The base of the housing of the cover can be visible through the notch and can have a corresponding marking in the open position of the quarter-turn latch.

To facilitate assembly, the cover can have an insertion device having an insertion ramp which not only serves to facilitate the insertion of the cover into receptacles for the axial pieces but also, owing to the spring loading, to eliminate play also under vibration loads, and an axial bore hole extending up to the spring-loaded axial piece allows easier disassembly in that a pin is pushed through and the axial piece is pressed out of its bearing.

It is useful for further assembly and/or disassembly when another coil spring is provided which presses the cover into the closed position.

### BRIEF DESCRIPTION OF THE DRAWINGS

The invention will be explained more fully in the following with reference to embodiment examples which are shown in the drawings.

### Brief Description of the Drawings

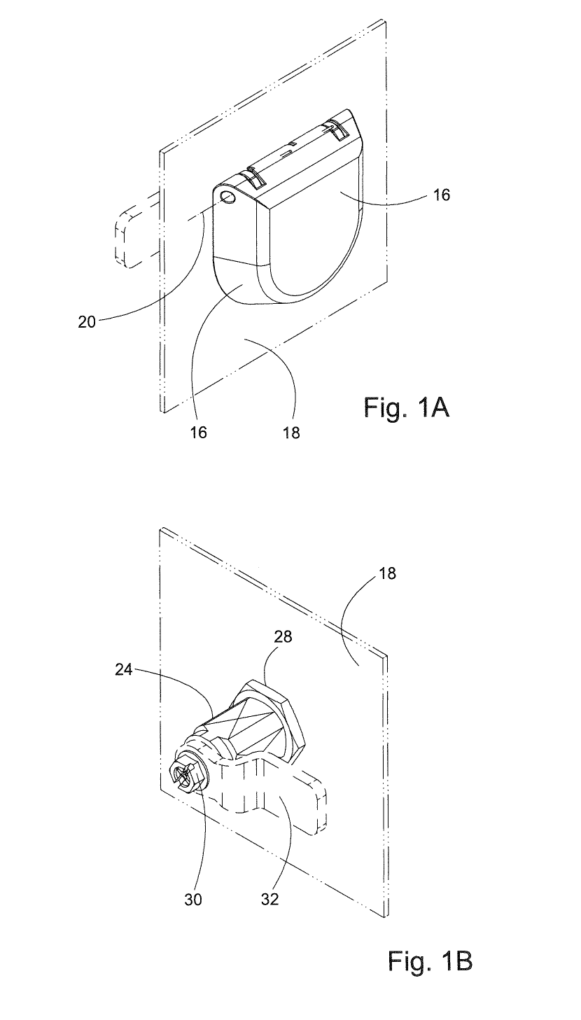

FIG. 1A shows a perspective top view of the quarter-turn latch with a key receptacle which is closed by a cover;

FIG. 1B shows the arrangement from FIG. 1A, but in a perspective rear view;

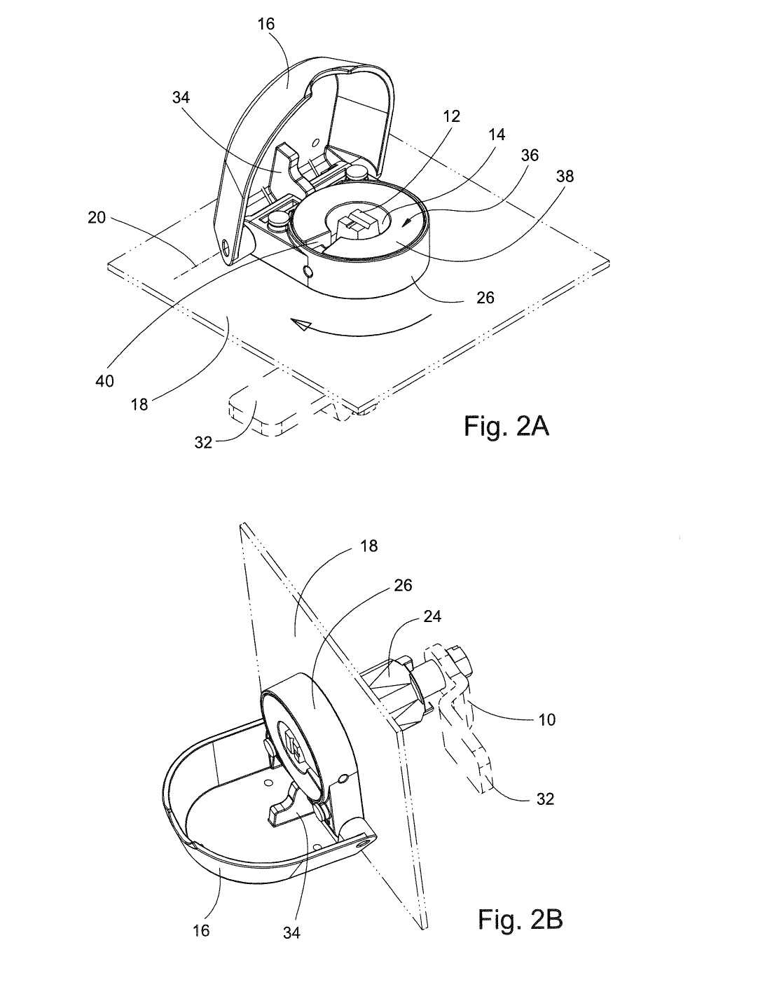

FIGS. 2A and 2B show corresponding views of the arrangement from FIGS. 1A and 1B, but with manually opened cover;

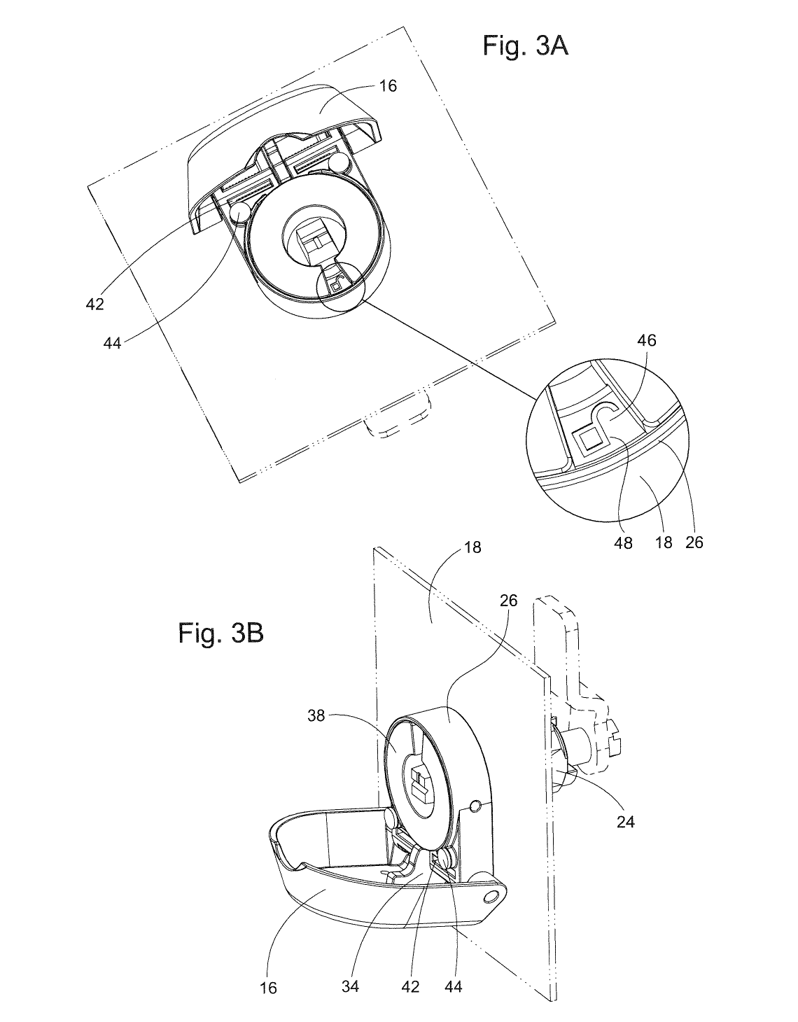

FIGS. 3A and 3B show views similar to FIGS. 1A and 1B of the quarter-turn latch after use through actuation and in the open position of the latch;

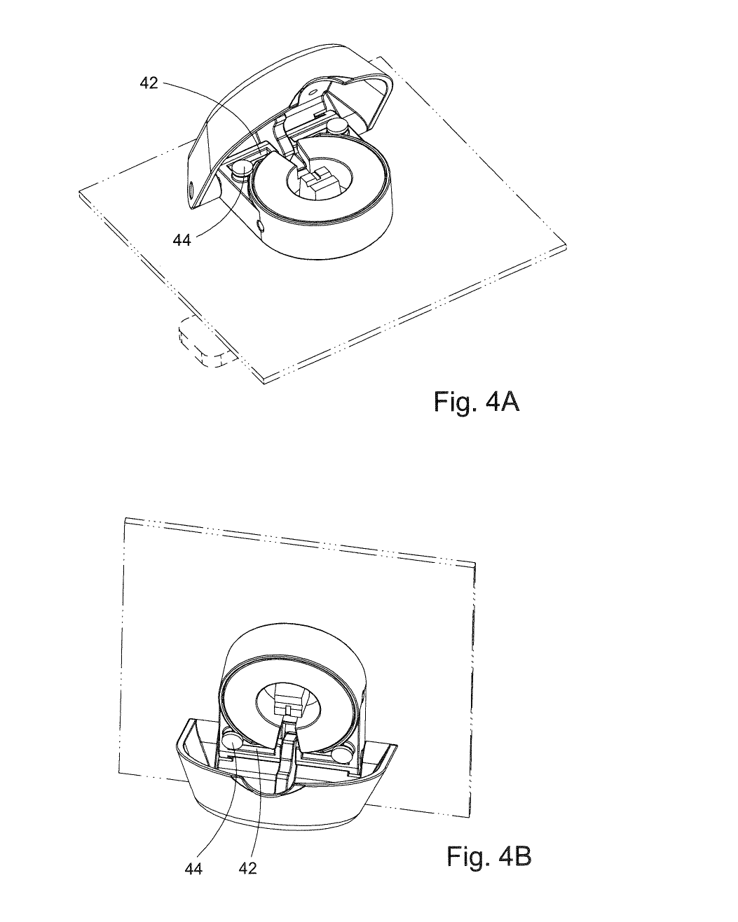

FIGS. 4A and 4B show corresponding views of the quarter-turn latch lock from FIG. 1A or 1B, wherein the cover is shown in the 11:30 position;

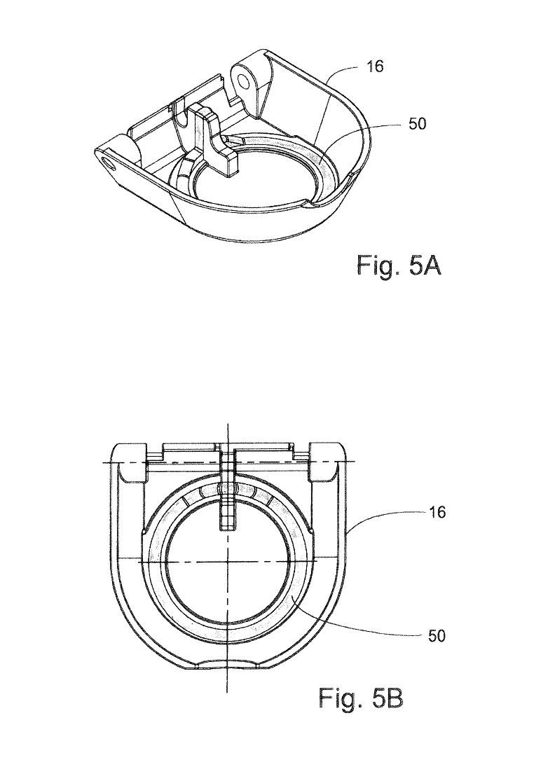

FIGS. 5A and 5B show an embodiment form with seal in a perspective view and a top view of the inside of the cover;

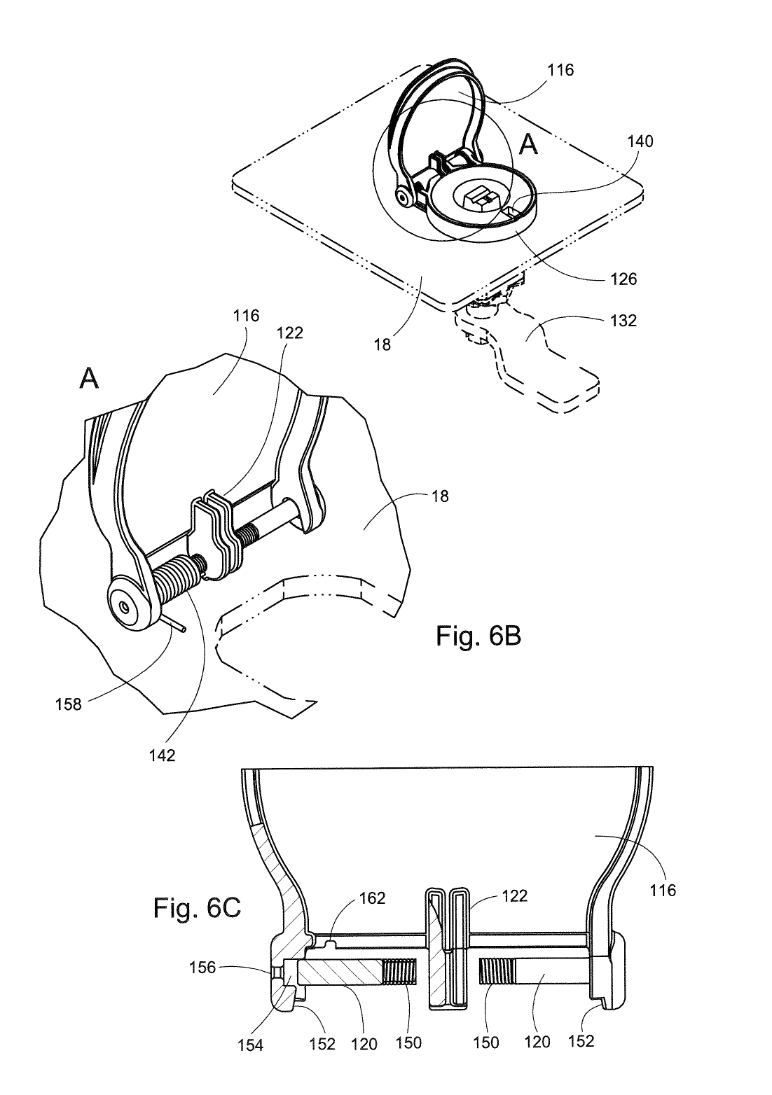

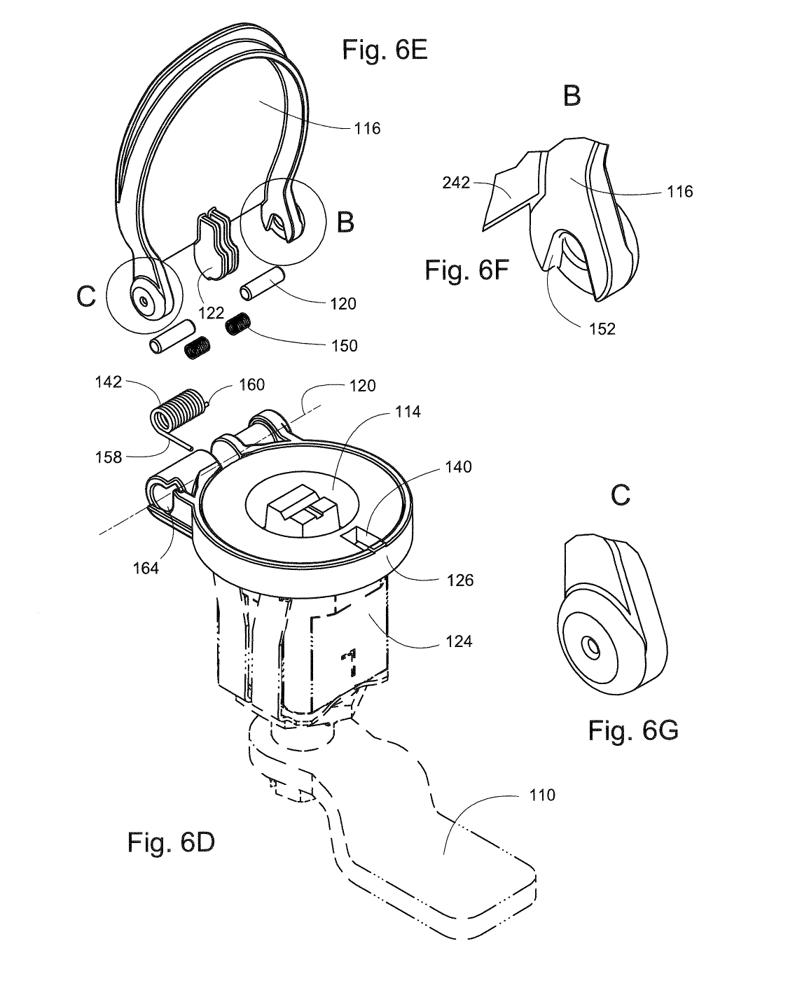

FIG. 6A shows a perspective view of a modified embodiment form;

FIG. 6B shows a detail of area A from FIG. 6A;

FIG. 6C shows an axial sectional view through this area;

FIGS. 6D and 6E show an exploded view of the overall arrangement; and

FIG. 6F and FIG. 6G show detail views of areas B and C from FIG. 6E.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

FIG. 1A is a perspective view of the quarter-turn latch 10 in front of a door leaf or the like 18. The quarter-turn latch 10 has a key receptacle 14 and a cover 16 which can be folded around an axis 20 parallel to the fastening plane 18 of the quarter-turn latch 10 out of an open position, as is shown in FIG. 2A, into a closed position, as can be seen in FIG. 1A. In other respects, the quarter-turn latch can have a conventional shape, for example, it can comprise a housing 24 which is held in a corresponding opening in the door leaf 18 by means of a flange 26 and a screw nut 28 and is provided with a driveshaft 30 with a sash fastener tongue 32 arranged at the end.

The driveshaft 30 carries a tongue 32; see FIG. 1B which is a perspective view from the rear of the arrangement according to the invention. The cover 16 can be folded around an axis 20 to the fastening plane 18 of the quarter-turn latch lock 10 out of an open position, as can be seen in FIGS. 2A and 2B, into a closed position, which is shown in FIGS. 1A and 1B. In its interior, a contour 22 protrudes in the area of the axis 20, which contour 22 is adapted to the contour 34 of the actuating means 36 in such a way that it fixes the actuating means with respect to rotation in the closed position of the cover, see FIG. 1A, and accordingly forms a lock safeguard which does not open unintentionally even under vibration motion.

The contour 34 of the actuating means 36 is preferably formed by a ring 38 which is rotatably supported with the actuating means 36, for example, at the bottom end, in the flange-like housing 24 and 26, respectively. The ring 38 has, at an angular position of the circumferential circle, a notch 40 in which the protruding contour 22 of the cover 16 can be received when the cover 16 is closed, as can be seen in FIGS. 4A and 4B, and thus allows the cover 16 to be closed, while outside this notch 40 the protruding contour 22 is held in opened position, as is shown in FIGS. 3A and 3B, against the force of a spring 42.

Due to the spring force, the cover is not dependent upon orientation, and the spring force can be generated by a spring 42 which is arranged between two protuberances 44. Possible variants indude a torsion spring 142 (FIG. 6D), a leaf spring, and a plastic lid 116 with injection-molded leaf spring 242 (FIG. 6F).

In the embodiment form shown in FIGS. 1A to 4B, the folding axis 20 of the cover 16 is formed by the flange 26 of the quarter-turn latch housing 24. But the folding axis of the cover can also be formed by a housing which is formed by the quarter-turn latch housing or by the flange thereof, not shown.

The base 46 of the housing 24 of the cover 16 is visible through the notch 40 and can have a corresponding marking 48, FIG. 3A, at the location of the open position of the quarter-turn latch.

In this way, the quarter-turn latch according to the invention has the character of a sash fastener as well as a position indicator and a dust protection cap which, depending on the desired degree of protection, can be provided with a seal 50, see FIGS. 5A and 5B, so as also to prevent penetration of water.

In this way, it is ensured that the cover remains in the open position when the lock is opened with a key or handle so as to be held by the contour in the position shown in FIG. 3A (open position, so that the key can be withdrawn without the safeguard being closed again as in the prior art. This is advantageous in many applications.

If the lock is moved into the closed position, see FIGS. 4A, 4B, with the key or the actuating means, the cover springs into the open position of the actuating means, locks the lock on the one hand and, on the other hand, fixes the lock against unwanted rotation due, for example, to vibrating movement, and prevents dust from penetrating.

In another embodiment form, shown in FIGS. 6A ff., the cover 116 is supported so as to be rotatable around a shaft 120 against the force of a spring 142 and allows a fast assembly and optional disassembly. The shaft parts 120 are supported, respectively, in a corresponding bore hole of the housing, namely, under axial pressure of one of two springs 150, respectively. The partial shaft 120 is accordingly accommodated so as to be axially displaceable in a corresponding bore hole in the edge area of the housing 124 and can be axially displaced against the force of the spring 150. When mounting the cover 116 on the housing 124, the spring part 150 accommodated in the housing and the adjoining axial pin 120 are displaced toward the center, which provides an assembly aid by means of an inclination 152 or a funnel-shaped inlet, which can be seen clearly in FIG. 6F. A shaft receptacle or pocket hole 154 in which the end of the axial pin 120 remote of the spring is anchored, namely under the force of the spring 150, is provided at the end of the shaft 120.

To dismantle the cover, another opening 156 can be provided which opens into the pocket hole 154 and allows the shaft 120 to be pushed out of the pocket bore 154 by means of a pin and the cover to be opened accordingly.

As can be seen clearly from FIG. 6D, a coil spring 142 is provided on the partial axial portion 120; on one side, this coil spring 142 presses on the door leaf plane 18 together with its end 158 and, with this end, presses on the cover 116 and tends to close it when the other end 160 of the coil spring 142 is anchored in the housing 124 at the same time.

This construction with the spring-assisted shaft allows a fast assembly and optional disassembly; further, the spring 150 ensures that play is minimized, provides for low noise and, if required, for an electrically conductive connection because the contact pressure exerted by the spring 150 is sufficient to electrically connect the cover 116 to the housing. Further, it is assured that a fast self-locking assembly is made possible in connection with the insertion means having the insertion ramp 152.

FIG. 6C shows, on the left-hand side, the axial pin 120 under compressive loading by the spring 150 prior to insertion into the bore hole 154. An insertion point 162 for the coil spring 142 is also shown.

### INDUSTRIAL APPLICABILITY

The invention is industrially applicable in switch cabinet construction, for example.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

10, 110 quarter-turn latch

12 key access

14, 114 key receptacle

16, 116 cover

18 fastening plane, door leaf

20, 120 axis, partial shaft

22, 122 contour of the cover interior

24, 124 housing

26, 126 flange

28 screw nut

30 driveshaft

32, 132 tongue

34 contour of the actuating means

36 actuating means

38 ring

40, 140 notch

42, 142, 242 spring, torsion spring, coil spring, leaf spring

44 protuberances

46 base

48 marking

50 seal

150 partial spring

152 inclined surface

154 pocket hole

156 bore hole

158 end

160 other end of the coil spring

162 insertion point

164 bearing bore hole

1. A quarter-turn latch comprising:
a quarter-turn latch housing;
a key receptacle; and
a cover for closing the access to the key receptacle;
wherein the cover is configured to be folded around an axis parallel to a fastening plane or door of the quarter-turn latch out of an open position into a closed position,
wherein a contour protrudes in an interior of the cover in a region of the axis, the contour being configured to the contour of the actuating means in such a way that the contour fixes the actuating means with respect to rotation in the closed position of the cover, the contour accordingly forming a lock safeguard.

2. The quarter-turn latch according to claim 1;
wherein the contour of the actuating means is formed by a ring which is connected to the actuating means so as to be rigid against rotation relative to the actuating means;
wherein the contour has, at an angular position of a circumferential circle of the contour, a notch in which the protruding contour of the cover is configured to be received when the cover is closed, thus allowing the cover to be closed; and
wherein, outside the notch, the protruding contour of the cover contacts the circumference of the ring and accordingly forces the cover in closed position by spring force.

3. The quarter-turn latch according to claim 2;
wherein the folding axis of the cover is formed by a flange of the quarter-turn latch housing.

4. The quarter-turn latch according to claim 2;
wherein the folding axis of the cover is formed by a housing which is held by the quarter-turn latch housing.

5. The quarter-turn latch according to claim 4;
wherein a base of the housing of the cover is visible through the notch and has a corresponding marking in the open position of the quarter-turn latch.

6. The quarter-turn latch according to claim 2;
wherein the spring force is generated by at least one of a torsion spring, a leaf spring of metal, and a leaf spring, which is injection molded from plastic integral with a cover.

7. The quarter-turn latch according to claim 1;
wherein the cover is provided with insertion means having an inclined surface for a self-locking quick assembly.

8. The quarter-turn latch according to claim 1;
wherein a shaft portion and a compression spring of the same diameter are arranged inside the bearing bore hole.

9. The quarter-turn latch according to claim 8, further comprising:
a pocket bore formed by the cover;
wherein the pocket bore is provided with a coil spring which is arranged coaxial to the shaft portion in such a way that the coil spring forces the cover into the closed position.

10. The quarter-turn latch according to claim 3;
wherein the spring force is generated by at least one of a torsion spring, a leaf spring of metal, and a leaf spring, which is injection molded from plastic integral with a cover.

11. The quarter-turn latch according to claim 4;
wherein the spring force is generated by at least one of a torsion spring, a leaf spring of metal, and a leaf spring, which is injection molded from plastic integral with a cover.

12. The quarter-turn latch according to claim 5;
wherein the spring force is generated by at least one of a torsion spring, a leaf spring of metal, and a leaf spring, which is injection molded from plastic integral with a cover.
